(19) United States
(12) Patent Application Publication
(10) Pub. No.: US 2022/0350299 A1
(43) Pub. Date: Nov. 3, 2022

(54) Real-Virtual Hybrid Venue

(71) Applicant: Digital Multiverse, Inc., Mayfield, KY (US)

(72) Inventor: Michael Christopher, Mayfield, KY (US)

(73) Assignee: Digital Multiverse, Inc., Mayfield, KY (US)

(21) Appl. No.: 17/732,459

(22) Filed: Apr. 28, 2022

Related U.S. Application Data
(60) Provisional application No. 63/183,177, filed on May 3, 2021.

(51) Int. Cl. G05B 19/042

(52) U.S. Cl. CPC G05B 19/042; G05B 2219/2614

(57) ABSTRACT

A real-virtual hybrid venue is formed from a three dimensional model of a real-world venue which is transformed into a virtual venue corresponding to the real-world venue. The virtual venue and the real-world venue it corresponds to would be interconnected to enable a user in the real venue to interact with a virtual user in the virtual venue as if they were both occupying the same environment. Both users would also experience the venue as if they were both occupying a shared venue such that a window blind opened in the real venue would result in a corresponding blind being opened in the virtual venue and a light turned on the virtual venue would result in a light being turned on in the real venue.

### FIELD OF THE INVENTIONS

The inventions described below relate to the field of hybrid real/virtual venues for human interaction.

### BACKGROUND OF THE INVENTIONS

Humans have been interacting in the real world for millennia and that has been the only place for people to interact. The advent of computers and gaming has enabled human interactions in increasingly elaborate virtual worlds, from electronics and multiplayer games, to online multiplayer games which evolved into massive multiplayer online games. Eventually multiplayer online games moved into a shared virtual space where the avatars for the real-world participants shared the same virtual space.

### SUMMARY

A real-virtual hybrid venue would develop a three-dimensional model of a venue and transform the three-dimensional model into a virtual venue. The virtual venue and the real-world venue it corresponds to would be interconnected or integrated to enable a user in the real venue to interact with a virtual user in the virtual venue as if they were both occupying the same environment. Both users would also experience the venue as if they were both occupying a shared venue such that a window blind opened in the real venue would result in a corresponding blind being opened in the virtual venue and a light turned on the virtual venue would result in a light being turned on in the real venue.

A real-virtual hybrid venue would be suitable for many different industries such as education, medicine, retail, manufacturing, business offices, finance, sports, entertainment, government, research and development etc. For example, a virtual doctor's visit may be accomplished with any necessary testing needed being performed by a remote-operated drone/robot. A user may participate in a college level medical biology class such as one in which cadavers are traditionally used for dissection. Similarly, an undersea marine biology course may be conducted with virtual students following a teacher through a real dive around a live coral reef using underwater drones or other suitable underwater vehicles. A shopping trip may be conducted by virtually moving through your local store's aisles, seeing what's available or on clearance, choosing exactly which fruits you want from the produce section or virtually interacting with something new in the electronics department before buying it. All of these interactions may be accomplished from a user's computer, mobile device, or any suitable platform to support a virtual data stream from their couch using any suitable platform including television and or a phone, and then having that order delivered or prepared for pick up. Alternatively, a user could work at a software development company or any other suitable industry, with any suitable combination of real, virtual and integrated offices for each employee as well as conference rooms and exposition zones.

The software implementing a real-virtual hybrid venue is meant to layer on top of or be able to access any suitable network or web platforms, both 2D and 3D, such as OpenSimulator or AltVR. The real-virtual hybrid venue software is intended to cover the reality integration layers to integrate with as many base cloud and virtualization platforms as is feasible with any suitable network or web platforms. The real-virtual hybrid venue software includes a database with sockets defined through the component level in increasing levels of detail that can allow a remote server to use as much or as little of the user's personally defined presence as is chosen by the user based on the remote system's capacities and settings.

### BRIEF DESCRIPTION OF THE DRAWINGS

FIG. 1 is a top view of a three-dimensional real-world venue.

FIG. 2 is a top view of a three-dimensional virtual venue corresponding the real-world venue of FIG. 1.

FIG. 3 is a block diagram of a network supporting a real-virtual hybrid venue system.

FIG. 4 is a block diagram of a primary database for a real-virtual hybrid venue system.

FIGS. 5A, 5B, 5C, 5D and 5E illustrate a block diagram of an alternate primary database for a real-virtual hybrid venue system.

### DETAILED DESCRIPTION OF THE INVENTIONS

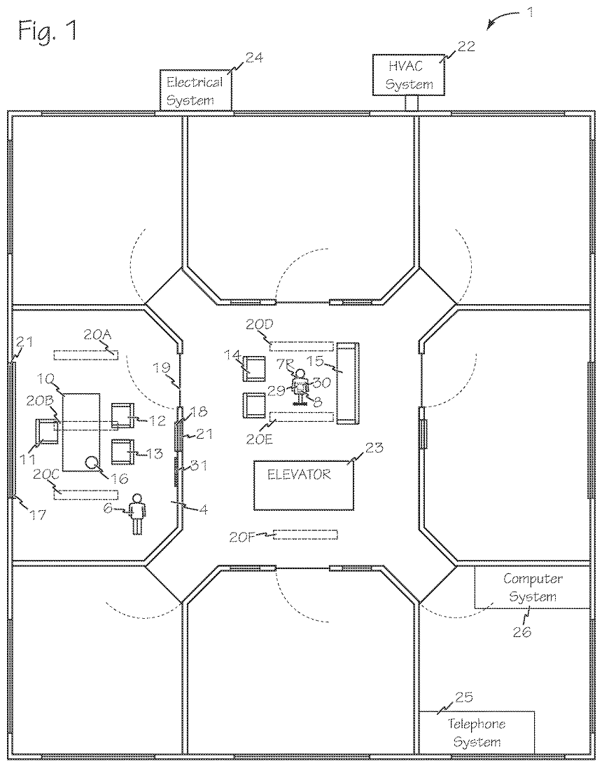

FIG. 1 is a top view of a three-dimensional real world venue, for example, work environment 1. In work environment 1 there are multiple offices, each office may have the same or different furniture such as desk 10, chairs 11, 12, 13 and 14, couch 15 desk lamp 16, window shades 17 and 18, door 19 and ceiling lights 20A, 20B, 20C, 20D, 20E and 20F.

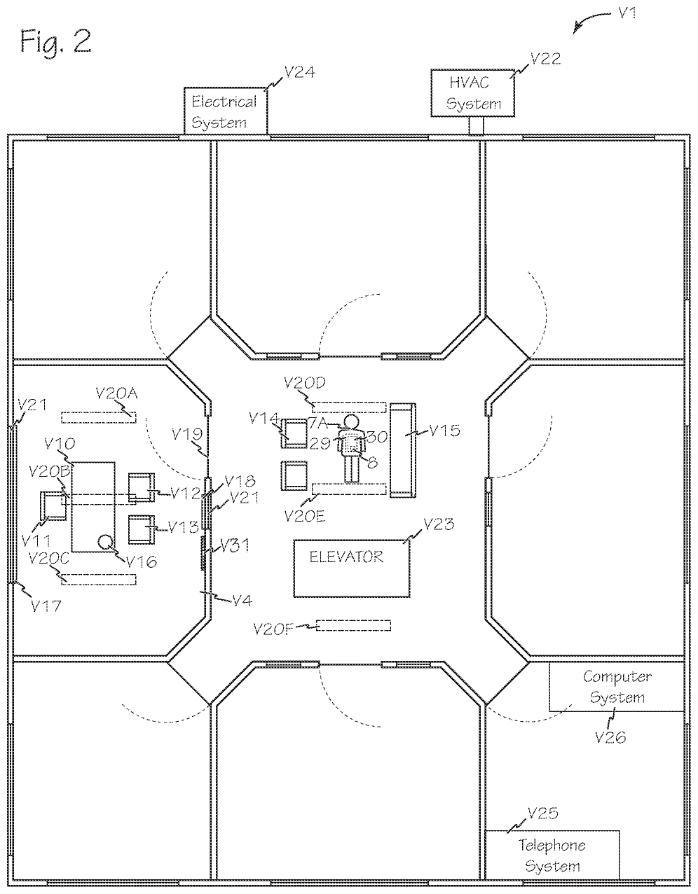

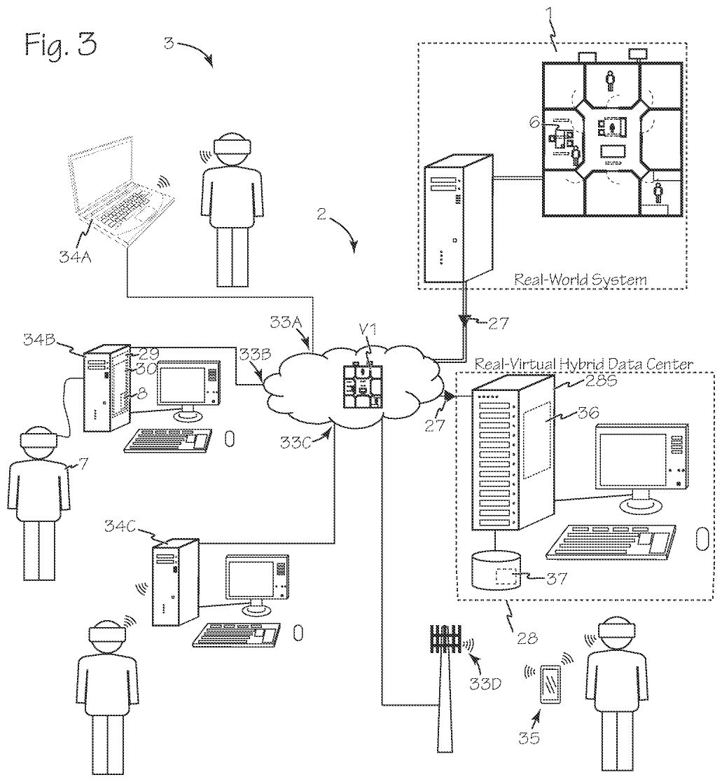

FIG. 2 is a top view of a three-dimensional virtual venue, virtual work environment V1. Virtual work environment V1 corresponds to real work environment 1. In virtual work environment V1 the three-dimensional real work environment 1 is presented including any and all furniture and decorations such as desk V10, chairs V11, V12, V13 and V14, couch V15 desk lamp V16, window shades V17 and V18, door V19 and ceiling lights V20A, V20B, V20C, V20D, V20E and V20F. A real-world user such as user 6 in real work environment 1 that turns on one or more lights such as light 20A causes the analogous light(s), virtual light V20A, to appear as illuminated in virtual work environment V1. Similarly, a virtual user 7 of FIG. 3, represented in virtual work environment V1 by avatar 7A may open virtual window shade V17 revealing a virtual view through virtual window V21. A real-world user such as user 6 in real office 4 would see window shade 17 change position and the user would be exposed to the view through window 21. Similarly, real-world user 6 in work environment 1 may see and interact with virtual user 7 via the virtual user's real world robot 7R illustrated in FIG. 1, or using virtual user avatar 7A on any suitable display such as display 31.

Remote automation of a real-virtual hybrid venue requires access points to integrate the real-world space, work environment 1, with the virtual space, virtual work environment V1. The extent of remote automation required by a real-virtual hybrid venue corresponds to the importance of the entity/venue's virtual presence. In general, functions and systems such as heating, ventilation and air conditioning (HVAC), HVAC system 22, elevators such as elevator system 23, electrical, such as electrical system 24 and plumbing systems would be relevant to the maintenance department even if efficiency and process improvement isn't important to a company's virtual presence. The telephone system 25 and the computer network 26 are systems that would require automation in the form of one or more sensors and controller interfaces such as sensors 25S and 26S and controllers 25C and 26C providing data 27 to the real-virtual hybrid venue datacenter 28 to support the real-virtual hybrid venue system 3.

Creation of a real-virtual hybrid venue generally begins with a 3-dimensional scan of a real venue such as venue 1 to create a digital model to become the virtual space V1 corresponding to the venue. Alternatively, a real venue may be digitally modelled from photographs, renderings, video or any other suitable means.

In the real-world a virtual user, such as user 7 of FIG. 3, may be represented in the real venue 1 by any suitable remotely controllable interaction unit such as a display 31, a moveable display, automated shopping cart, drone, robot or other suitable representative such as robot 7R. Robot 7R or a suitable display will include the virtual user's digital self 29 and user avatar 7A. Digital self 29 may include any suitable digital data to represent the virtual user in that venue. A user with access to multiple virtual venues may have different digital selves such as digital self 29 in each venue to which they have access. People carry many things on their person in different circumstances, such as their identification documents, money, credit cards, medical/health insurance cards and data, all of which may be reduced to electronic data 30. Digital self 29 may include any suitable personal digital information such as health metrics (height, weight, blood pressure, sugar levels, surgical history, allergies, etc.) as well as identity metrics such as eye color, retinal pattern, fingerprints, voice pattern, payment methods, insurance, etc. Embedded and smart devices that report a user's data, such as health related data, would add any new relevant data to the user's digital self 29 with each reading taken, stored. Selected individuals or companies such as medical practitioners, employers or others could be granted access to curated portions of a user's digital self 29 and or electronic data 30 as determined appropriate by the user, such as electronic data portion 8. Any suitable analysis of collated health data from digital self 29, such as by using artificial intelligence, can provide earlier warning of issues and thus recommend less invasive treatment routes when the problem is in an earlier state, as can be done just as easily as merchant transactions are done now.

Drone and automation technology is now affordable enough for doctors to use medical drones for remote patient visits to include taking metrics where the need exists, such as blood pressure and pulse readings, sugar levels, EKG, ECG, blood samples, etc. Such drones can easily carry a inexpensive but energy efficient screen, wifi+cell chip, and camera for the doctor operating it to interact live on arrival as a “virtual house call”, to extend the virtual live remote interaction capacity available through the real-virtual hybrid venue.

In use, remote sensors and remote automation are used to inform virtual space V1 or interact between work environment 1 and the virtual environment V1. Sensors, controllers and other automation components that may be incorporated into the real-world work environment 1 include but are not limited to sensors and automation components such as cameras, smart speakers with and without screens, motion sensors, light sensors, sound sensors (separate from smart speakers, cameras, and phone/tablet/computer microphones) humidity sensors, temperature sensors (both thermostat and non-controlling sensors), smoke/co2 sensors, glass break detectors, video doorbells, door/window contact sensors, smart outlets (which can be hardwired in-wall or plugged in to a standard outlet like the smart plugs), air flow sensors, liquid pressure sensors, gas pressure sensors, smart electrical multimeters, smart switches (both wired and wireless variants, including on/off, dimmer, fan control presets, etc), smart bulbs, printers, air filter, humidifier/dehumidifier, emergency heat exhaust vent, network/cloud monitored/controlled battery backup systems, uninterruptable power systems, generator power systems, company phone/desk phone. Fixed or mobile display screens such as display 31 may be integrated in the real-world venue to represent virtual users in the real-world venue. The mobile display screen or screens will display the user's video image or avatar and may optionally include speakers and or any other suitable components for interacting in the real-world venue such as moving and carrying things in the real world.

Additional systems that may also be used include door automation & security (secured and public), fire suppression system monitoring and control, plumbing automation, AI process and efficiency analysis to include system array placement and usage. Sensors and monitoring devices such as cameras may be isolated from control devices such as measuring tools and drones a repair person might use for diagnostics and repair, to enable management and security to watch automated assembly/manufacturing equipment that has its own remote operational control and for maintenance to perform remote diagnostics and repairs. Sensors may be integrated with control devices to automate any suitable systems.

FIG. 3 is a block diagram of a network 2 supporting a real-virtual hybrid venue system 3. Network 2 may be the World Wide Web (internet) or any suitable private network that may or may not be connected to the Internet. Real-virtual hybrid venue datacenter 28 includes at least one server such as server 32 and the datacenter and any servers can be monitored by system admins remotely and the only people that have any need to physically ever be present are those responsible for keeping the physical location and hardware in operation and online. As long as there is power and any suitable network connection to the physical venue 1, it should be fully remotely accessible. Real-virtual hybrid venue datacenter 28 may be a stand alone center with one or more computer servers such as server 28S as illustrated or it may be a server integrated in computer network 26. Each server/computer monitor's physical power button is left “On” and each computer is plugged in to a smart switch, with its state and power usage remotely reported and controlled, so whether it is turned on in person in the physical office or virtually in the office clone, the other location changes state to match, all battery backups have remote network management cards, and every other device is likewise somehow remotely enabled. Temperature, humidity, and air quality are directly monitorable through multiple simultaneous channels (as failovers are important for core factors) and controllable remotely as well as locally.

Real-virtual hybrid venue datacenter 28 uses a mixed desktop as a service (DaaS) solution with any suitable combination of Windows, Linux, Apple or other virtual machine workstations for the real-virtual venue infrastructure to maintain visibility and control of employee systems while reducing hardware costs for remote work. Remote users can access the virtual venue via any suitable number of access ports such as access ports 33A, 33B, 33C or 33D and use any suitable endpoint device such as computers 34A, 34B and or 34C or mobile devices such as mobile device 35 to access company resources remotely while avoiding the risk of that employee (or their pets or children) damaging the expensive company property. Similarly, real-world venues can use inexpensive workstations/thin clients for the actual physical employee desks and give those workstations the same remote DaaS desktops as if they were at home for the same purpose.

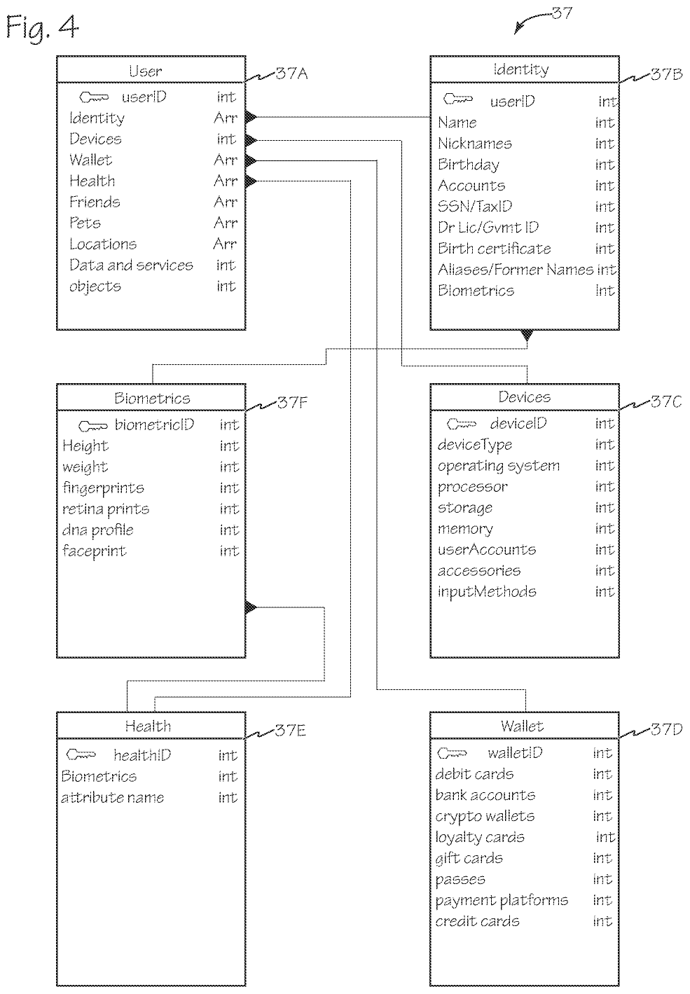

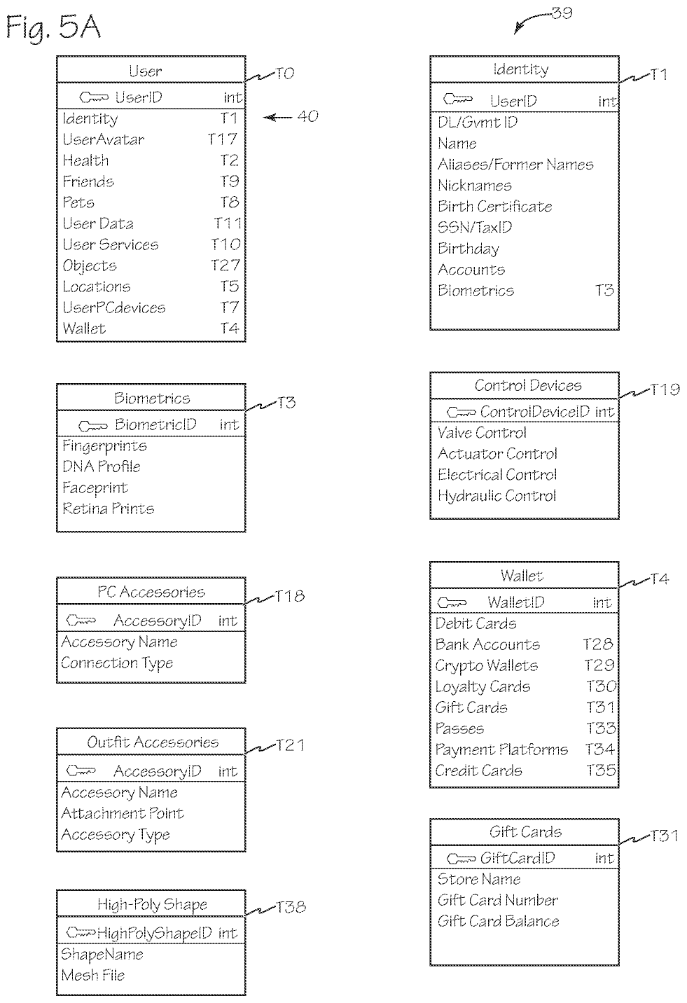

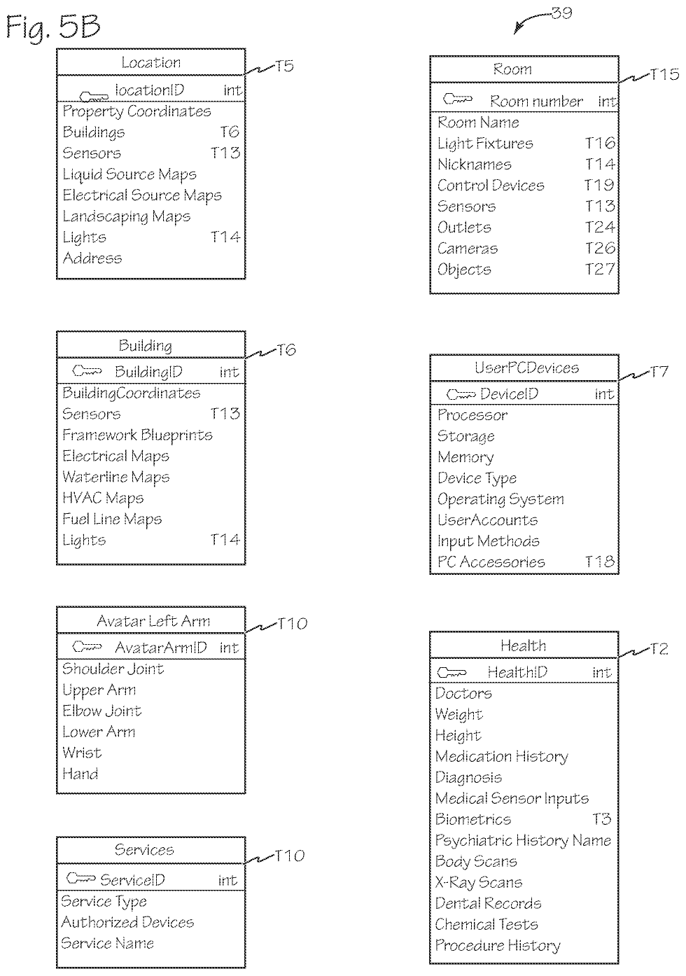

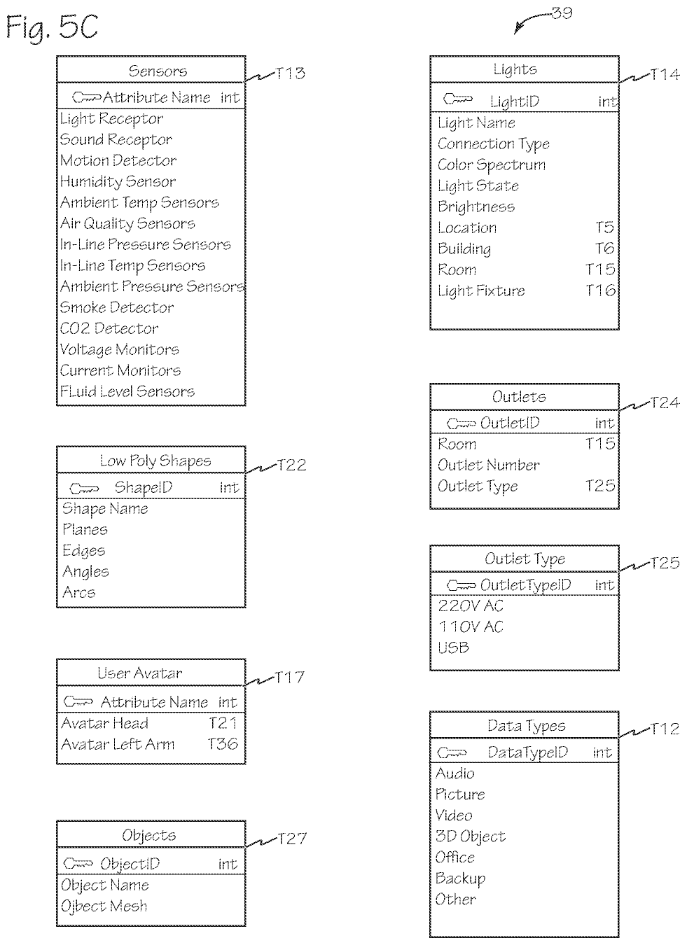

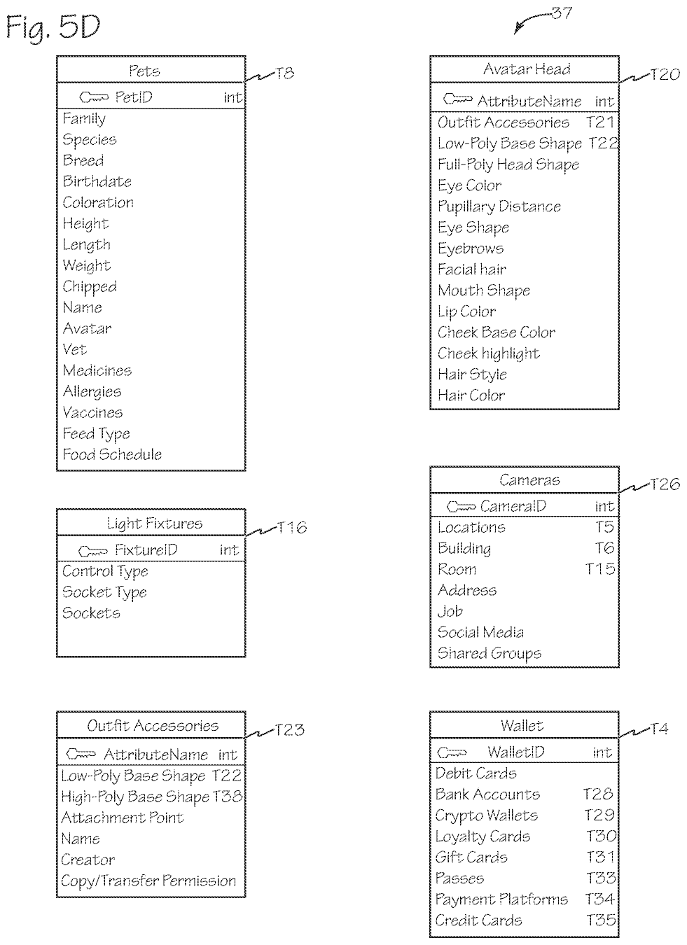

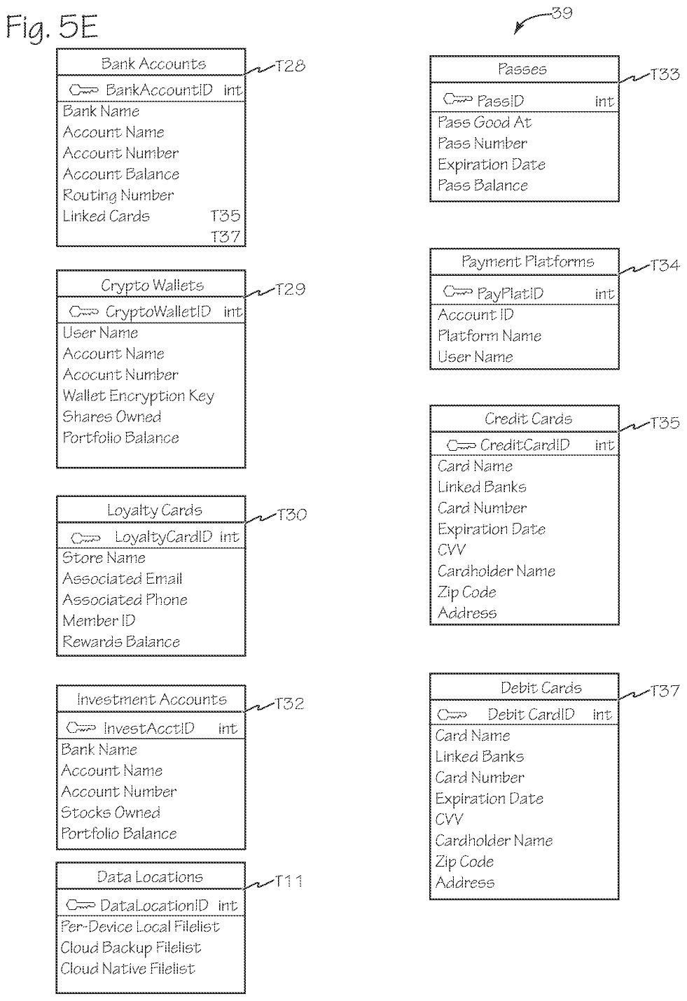

Real-virtual hybrid venue datacenter 28 includes real-virtual hybrid venue software 36 which also includes a primary database 37 which may be configured as first database 38 illustrated in FIG. 4 or alternate database 39 illustrated in FIGS. 5A, 5B, 5C, 5D and 5E or any other suitable configuration. First database 38 and alternate database 39 are included as examples. Primary database 37 includes sockets, such as sockets 37A, 37B, 37C, 37D, 37E and 37F defined through the component level in increasing levels of detail to allow a remote device/computer/server to use as much or as little of a user's personally defined presence, digital self 29, as is chosen by the user based on the remote system's capability. Primary database 37 is for example and any suitable number and selection of sockets may be used with any suitable level of detail. Alternate database 39 illustrates a plurality of database tables numbered T0 through T39 and the interrelationships between the tables are illustrated by the connections labeled within the tables directing the software to another table such as the user table T0 in FIG. 5A which contains a reference to user identity and a link to T1 illustrated at point 40.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A real/virtual hybrid venue system comprising:
A real-world venue configured with a plurality of displays, sensors and automation components;
a real-virtual hybrid venue datacenter operably connected to the plurality of sensors and automation components in the real-world venue via a network;
A virtual venue produced by the real-virtual hybrid venue datacenter corresponding to the real-world venue; and
A plurality of access ports configured to enable a plurality of users to access the virtual venue via the network and interact with the real-world venue and any users therein.

2. The real/virtual hybrid venue system of claim 1 wherein the real-virtual hybrid venue datacenter further comprises:
one or more servers operably connected to the plurality of sensors and automation components in the real-world venue via a network;
a primary database operably connected to at least one of the one or more servers.

3. The real/virtual hybrid venue system of claim 1 wherein the network is the Internet.

4. The real/virtual hybrid venue system of claim 1 wherein the network is a private network.

5. The real/virtual hybrid venue system of claim 1 wherein the plurality of displays sensors and automation components further comprise:
One or more displays, one or more sensors and one or more automation components operably connected to a telephone system.

6. The real/virtual hybrid venue system of claim 1 wherein the plurality of displays sensors and automation components further comprise:
one or more displays, one or more sensors and one or more automation components operably connected to a computer system.

7. The real/virtual hybrid venue system of claim 1 wherein the plurality of displays sensors and automation components further comprise:
one or more displays, one or more sensors and one or more automation components operably connected to a heating, ventilation and air conditioning system.

8. The real/virtual hybrid venue system of claim 1 wherein the plurality of displays sensors and automation components further comprise:
one or more displays, one or more sensors and one or more automation components operably connected to an elevator system.

9. The real/virtual hybrid venue system of claim 1 wherein the plurality of displays sensors and automation components further comprise:
one or more displays, one or more sensors and one or more automation components operably connected to a computer system;
one or more displays, one or more sensors and one or more automation components operably connected to a telephone system;
one or more displays, one or more sensors and one or more automation components operably connected to an electrical system
one or more displays, one or more sensors and one or more automation components operably connected to a heating, ventilation and air conditioning system; and
one or more displays, one or more sensors and one or more automation components operably connected to an elevator system.

10. The real/virtual hybrid venue system of claim 1 wherein the real-world venue further comprises:
one or more remotely controllable interaction units.

11. The real/virtual hybrid venue system of claim 10 wherein the one or more remotely controllable interaction units are selected from the following:
a fixed display, a moveable display, an automated shopping cart, a drone or a robot.

12. The real/virtual hybrid venue system of claim 1 wherein the real-virtual hybrid venue datacenter is a server integrated into a network in the real-world venue.

13. The real/virtual hybrid venue system of claim 12 wherein the real-virtual hybrid venue datacenter server is operably connected to a primary database.

14. The real/virtual hybrid venue system of claim 1 wherein the real-world venue is selected from one of the following industries:
education, medicine, retail, manufacturing, business offices, finance, sports, entertainment government, research and development.

15. A method for a first user a real-world venue to interact with a second user in a virtual venue corresponding to the real-world venue comprising the steps:
providing a real-world venue configured with a plurality of displays, sensors, automation components and remotely controllable interaction units;
providing a real-virtual hybrid venue datacenter having one or more servers operably connected to a primary database, the one or more servers operably connected to the plurality of displays, sensors, automation components and remotely controllable interaction units in the real-world venue via a network, the;
providing virtual venue produced by the real-virtual hybrid venue datacenter corresponding to the real-world venue;
providing a plurality of access ports configured to enable a plurality of users to access the virtual venue via the network and interact with the real-world venue and any users therein; and
connecting the second user to the real-virtual hybrid venue datacenter via a network wherein the remote user remotely controls a remotely controllable interaction unit to interact with the first user in the real-world venue.

16. The real/virtual hybrid venue system of claim 15 wherein the one or more remotely controllable interaction units are selected from the following:
a fixed display, a moveable display, an automated shopping cart, a drone or a robot.

17. The real/virtual hybrid venue system of claim 15 wherein the real-world venue is selected from one of the following industries:
education, medicine, retail, manufacturing, business offices, finance, sports, entertainment, government, research and development.
